(19) United States
(12) Patent Application Publication
(10) Pub. No.: US 2007/0079644 A1
(43) Pub. Date: Apr. 12, 2007

(54) Ripe melon detector

(76) Inventor: Brian W. Clark, Sun Valley, NV (US)

Correspondence Address: LITMAN LAW OFFICES, LTD, PO BOX 15035, CRYSTAL CITY STATION, ARLINGTON, VA, 22215, US

(21) Appl. No.: 11/546,431

(22) Filed: Oct. 12, 2006

Related U.S. Application Data
(60) Provisional application No. 60/725,288, filed on Oct. 12, 2005.

(51) Int. Cl. G01N 3/32

(52) U.S. Cl. 73/12.01

(57) ABSTRACT

The ripe melon detector determines the ripeness of opaque fruit including melons by determining the resonant frequency of the melon and correlating the resonant frequency with information of expected frequency for ripe melons. The detector includes a sound transmitting transducer, a transducer for receiving sound from the melon and a control circuit. An operator control causes the control circuit to control the sound transmitting transducer to transmit sound frequencies to the fruit. The control circuit controls the receiving transmitter to receive sound returned from the fruit. The sound frequencies in the received sound are analyzed by comparing them to expected frequencies to provide a determination of the ripeness of the fruit. An indicator system driven by the control circuitry provides an indication of the ripeness of the fruit. The indicator system may include indicator lights, a speaker, or a text display.

### CROSS-REFERENCE TO RELATED APPLICATION

This application claims the benefit of U.S. Provisional Patent Application Ser. No. 60/725,288, filed Oct. 12, 2005.

### BACKGROUND OF THE INVENTION

1. FIELD OF THE INVENTION

The present invention relates to devices for evaluating the condition of agricultural produce, and more particularly, to a ripe melon detector for evaluating the ripeness of a melon.

2. DESCRIPTION OF THE RELATED ART

When selecting produce for purchase, it is important to buyers that the goods have an optimal state of ripeness. For fruits such as apples, or bananas, for example, ripeness can be determined by evaluating external characteristics of the fruit such as color or firmness.

For other items, including melons, such as watermelon, cantaloupes, or honeydew melons, the color of the exterior rind is not strongly correlated with freshness. Further, the opaque rind prevents viewing the meat of the melon. In some cases, the freshness of melons can be determined by the aroma given off by the melons. However, melons are often chilled for transport, and chilling has the effect of diminishing the aroma given off by the melons.

The most reliable method for evaluating the ripeness of some fruits, such as melons, is to cut into the rind to view the inner fruit. However many people prefer to purchase uncut melons. Once a melon is cut open, the melon will remain fresh for only a very short time, up to a few days, while an uncut melon may be stored for a week or more. Melons also have the characteristic that they do not ripen further after they have been cut from their vines. This non-ripening characteristic means that growing melons should be verified as being ripe before being harvested and without cutting into the melon.

Thus, it is desirable to test the freshness of produce such as melons using a non-destructive technique.

One often used technique for evaluating the freshness of watermelons, for example, involves thumping the watermelon and listening to the generated sound. A hollow sound indicates a fresh melon, while a sharp ringing sound indicates an unripe melon. A dead sound indicates an over ripe melon.

To an untrained ear, the differences in sound between melons of various stages of ripeness can be subtle and difficult to discern, making the thumping technique prone to errors and likely to generate inconsistent evaluations of ripeness. A device producing a more consistent evaluation of results and allowing novices to evaluate ripeness is desirable.

Some efforts have been made to develop a noninvasive device to detect the ripeness of melons and other fruits or foods, or detecting internal characteristics of an object by sound. An exemplary device is shown in Japanese Patent No. 58-750, published Jan. 5, 1983, which describes a vegetable or fruit ripeness detector that analyzes the vibration generated from striking a fruit or vegetable, combined with visual shape information, to determine the ripeness of the fruit or vegetable. Japanese Patent No. 60-203,820, published Oct. 15, 1985, describes an apparatus for determining the characteristics of a machine by monitoring the noise generated by the machine. Japanese Patent No. 2-240,561, published Sep. 25, 1990, describes testing for a hollow spot in a watermelon by striking the melon with a ball and detecting the acoustic pressure of a resultant wave passing through the watermelon by attaching an acoustic sensor to the opposite side of the watermelon with a suction cup. Japanese patent document JP 62-5174, published Jan. 12, 1987 and Japanese patent document JP 62-5175, published Jan. 12, 1987 describe ultrasonic transmitting and receiving elements for detecting waves reflected from a liquid/solid interface. Japanese Patent No. 62-44,660, published Feb. 26, 1987, describes a method of detecting ripeness of a watermelon by applying an impulse to the melon and measuring the amplitude of a low frequency vibration generated by the impulse.

Japanese Patent No. 2-193,062, published Jul. 30, 1990, describes a system for comparing optical measurements of an object, such as a watermelon, under still conditions and during resonant vibration and detecting the density of the watermelon.

None of the above inventions and patents, taken either singly or in combination, is seen to describe the instant invention as claimed. Thus, a ripe watermelon detector solving the aforementioned problems is desired.

### SUMMARY OF THE INVENTION

The ripe melon detector determines the ripeness of opaque fruit including melons by determining the resonant frequency of the melon and correlating that resonant frequency with information concerning the expected frequencies for ripe melons. The detector includes a sound transmitting transducer, a transducer for receiving sound from the melon and a control circuit. An operator control causes the control circuit to control the sound transmitting transducer to transmit sound frequencies to the fruit. The control circuit controls the receiving transmitter to receive sound returned from the fruit. The sound frequencies in the received sound are analyzed by comparing them to expected frequencies to provide a determination of the ripeness of the fruit. An indicator system driven by the control circuitry provides an indication of the ripeness of the fruit. The indicator system may include indicator lights, a speaker, or a text display.

The ripe melon detector may include a portable housing with the control circuit housed within the housing, and operator controls, indicators and displays mounted to the exterior of the enclosure. The transducers are mounted to an external surface of the enclosure allowing them to be placed in contact with a fruit to be tested.

A number of analyses may be performed to evaluated ripeness based on the returned sound. In one embodiment, a Fast Fourier Transform (FFT) is performed on a digital representation of the returned sound. After the received signal has been transformed to the frequency domain, the resonant frequency can be identified and compared to a range of frequencies expected for ripe fruit. In another embodiment, a correlation of the frequency domain representation of the received sound and a stored frequency domain of an expected received signal for a ripe fruit is computed, with the resulting correlation providing an indication of ripeness.

These and other features of the present invention will become readily apparent upon further review of the following specification and drawings.

### BRIEF DESCRIPTION OF THE DRAWINGS

FIG. 1 is an environmental perspective view showing a worker testing the ripeness of watermelons with a ripe watermelon detector according to the present invention.

FIG. 2 is a front view of a ripe melon detector according to the present invention.

FIG. 3 is a block diagram of exemplary circuitry for a ripe melon detector according to the present invention.

FIG. 4 is a flowchart showing the process for determining the ripeness of a melon with a ripe melon detector according to the present invention.

Similar reference characters denote corresponding features consistently throughout the attached drawings.

### DETAILED DESCRIPTION OF THE PREFERRED EMBODIMENTS

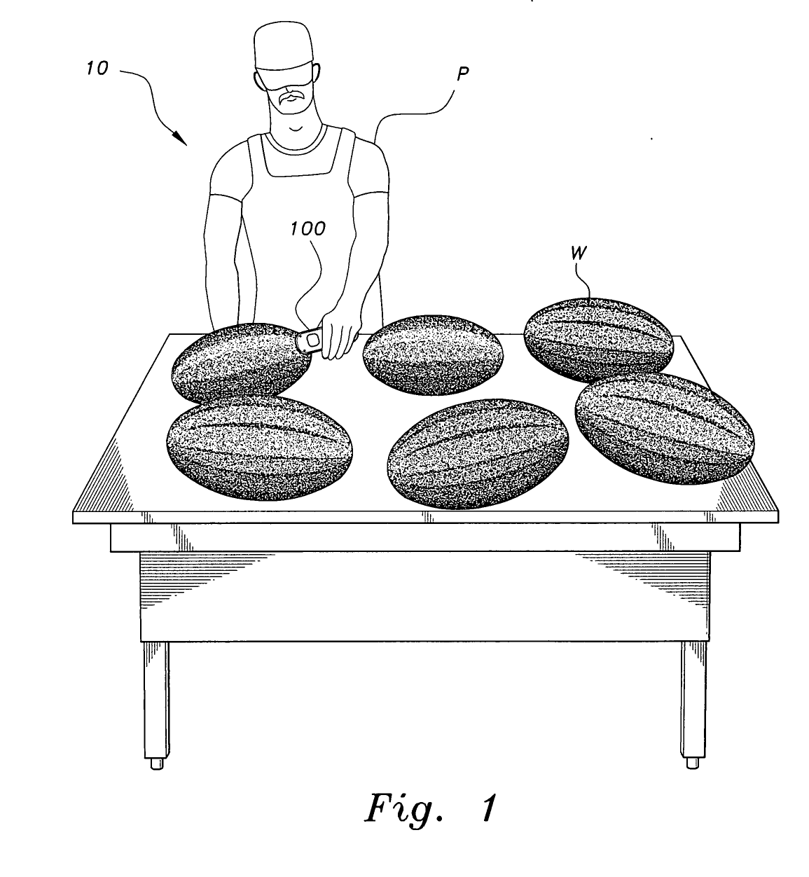

FIG. 1 illustrates the use of a portable ripe watermelon detector 100 according to the present invention in a melon ripeness detection operation 10. An operator P holds the ripe watermelon detector 100 in contact with a melon, such as watermelon W, for which ripeness is to be determined.

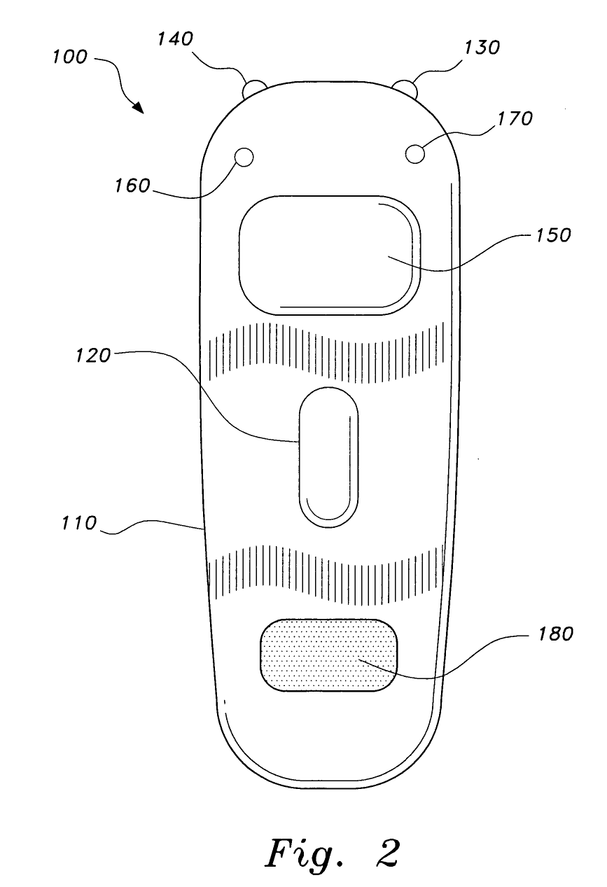

Referring to FIG. 2, in the contacting position, a watermelon W is contacted by a pair of sound transducers 130 and 140. The operator P activates the ripe melon detector 100 by pressing a button 120 located on the enclosure 110 of the ripe melon detector 100.

Upon activation, control circuitry within the ripe melon detector 100 transmits sound to the watermelon W via the transmitting transducer 140. The transmitting transducer 140 converts an electrical signal from the control circuitry into sound energy. For example the transmitting transducer may be a piezoelectric sound generator driven by an alternating current waveform containing one or more frequency components generated in the control circuitry. The sonic response of the watermelon to the transmitted sound is received by circuitry of the ripe melon detector 100 via the receiving transducer 130. The receiving transducer 130 may be a second piezoelectric device operated to convert the mechanical vibrations of the watermelon into an electric signal.

The received sound is analyzed to generate resonant frequency information associated with the watermelon W. The resonant frequency information is correlated with the frequency information for watermelon of various stages of ripeness to determine the ripeness of the tested watermelon W. The ripeness state of the watermelon is provided to the operator P via one or more indicators on the exterior of the enclosure 110 of the ripe watermelon detector 100. For example the ripeness state of a watermelon may be characterized as “ripe”, “under ripe”, and “over ripe”. The detector may indicate the ripeness state via an audio speaker 180 by use of tones assigned to each state of ripeness. Ripeness may also be indicated by illuminating one or more of indicator lights 160 and 170. The indicator lights 160 and 170 may be illuminated individually or in combination to indicate the state of ripeness of the watermelon. For example, a first indicator light 160 may be lit to indicate an under ripe melon, a second indicator 170 may be illuminated with the first indicator light 160 turned off to indicate an over ripe melon, while simultaneously illuminating the indicators indicates a ripe melon. An indicator light may also indicate ripeness state information by flashing on and off, shining with a steady illumination or not being illuminated. A quantitative indication of ripeness may be provided my modulating the intensity of illumination of an indicator or the rate of flashing, or both.

Ripeness may also be indicated on a text display 150. Text based messages may be used to indicate states of ripeness of the target watermelon W. Melons may be categorized into qualitative states such as “ripe”, “under ripe”, and “over ripe” or alternatively quantitative indications of ripeness may be provided. For example, the display may indicate ripeness on a scale with ripeness and over ripeness at end sections of the scale, and degrees of ripeness indicated between the extremes. The display may also provide diagnostic information indicating proper operation of the control circuit. For example the display may provide an indication that the transducers have not been placed in proper contact with a watermelon.

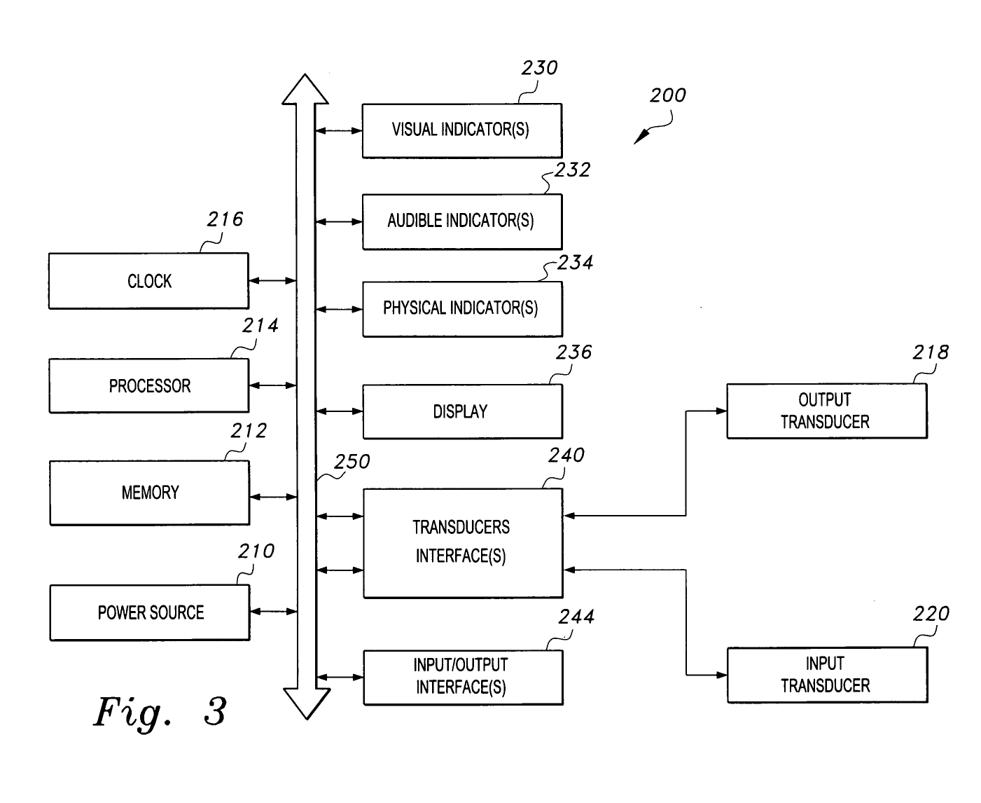

The construction of the control circuit 200 for evaluating and displaying ripeness for melons may be appreciated by referring to FIG. 3. The control circuit 200 is a computer system capable of carrying out the required functionality. The circuitry 200 includes a processor subsystem 214. The processor subsystem 214 may consist of one or more processing units. The processor subsystem 214 controls the operation of the other components by fetching and executing instructions and issuing commands to the various other components of the circuitry 200. In one embodiment, the processor subsystem 214 comprises a microprocessor/digital signal processor (DSP) combination wherein the DSP is a processing unit optimized for carrying out signal analysis, such as a Fast Fourier Transform (FFT) procedure.

The processor 214 is connected to a bus 250 over which computer instructions, control commands, and data are communicated to other components in of the control circuit. Communicatively coupled to the bus 250 are the processor 214, the clock 216, a computer readable memory 212, transducer interfaces 240, input/output interfaces 244, and one or more indicator systems interfaces.

The clock circuit 216 provides a time base input for the processor for proper sequencing of operations within the processor 214. The clock 216 signal may also be used as a timing reference for the accurate measure of time intervals associated with overall control circuit operation.

The computer readable memory 212 stores processor instructions to be executed by the processor subsystem 214 and data required to direct the operation of the control circuit. The computer readable memory 212 may include non-volatile read-only memory for storing the instructions of programs to be executed by the processor 214, and fixed data such as operating parameters, set points, and system configuration information. The memory may further include random access memory (RAM) that may contain the operating instructions for programs being executed by the processor subsystem 214, and temporary data generated by executing programs or read from devices communicating with the processor subsystem 214 via interfaces to the system bus 250.

The transducer interfaces 240 facilitate communication between the processor subsystem 214, and the input transducer 220 and the output transducer 218. The input transducer interface may perform such operations as noise filtering, analog-to-digital conversion, and phase and/or amplitude compensation to correct for transducer non-linearity.

The input/output interfaces 244 facilitate communication between the processor subsystem 214 and input/output devices controlled by the control circuit 200 to communicate with an operator using the ripe melon detector. Devices communicating via the input/output interfaces 244 include operator controls, such as the operating button (120 in FIG. 2) used to start a ripeness evaluation cycle.

Additional device specific interfaces may be provided to facilitate communication with the various indication devices that may be included with ripe melon detector 100. The indication interfaces include interfaces for the physical indicators 234, audible indicators 232, and the visual indicators 230. A display interface 236 facilitates communication between the processor subsystem 214 and the display.

The audible indicators 232 include the speaker (180 in FIG. 2) for delivering audible communications to an operator from the control circuit 200. The audible communications may include indication of ripeness as described above. Audible communications may further comprise diagnostic information related to correct operation of the control circuit 200 or of the overall detector.

The visual indicators 230 include the indication lights described above. The visual indicators 230 are controlled by the processor via the input/output interfaces 244 to provide a visual indication of ripeness.

A physical indicator interface 234 may be provided to facilitate communication with, and control of devices designed to provide mechanical feedback to the operator. For example, an electromechanical vibrating device, such as a low frequency buzzer, may be controlled to provide an inaudible indication to the user of the ripeness of a melon under test by providing tactile vibrations to the hand of the operator.

A power source may be provided for providing electrical power to the control circuit 200. The power source 210 may consist of one or more battery cells. The power source 210 may further include conditioning circuitry such as filters and circuitry for converting the voltage supplied by the one or more battery cells into voltage levels required by components of the control circuitry 200.

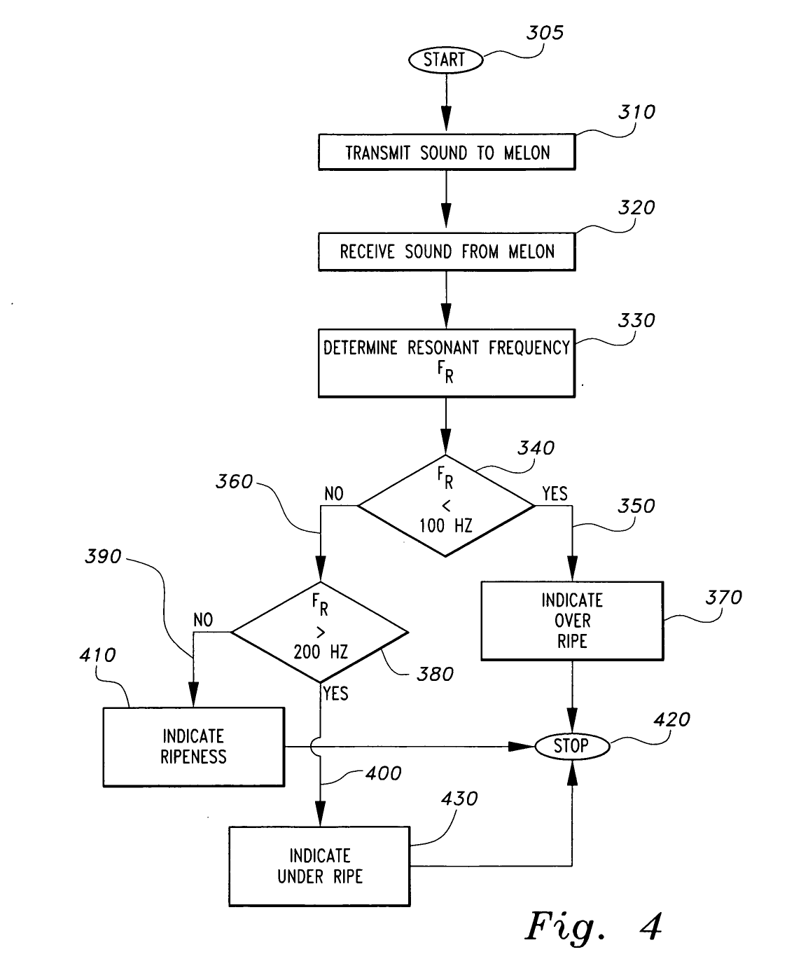

The functionality implemented by the ripe watermelon detector control circuit may be understood by referring to FIG. 4 and FIGS. 1 and 2. In the computer system implementation described above, the process diagramed in FIG. 4 is carried out by software instructions read from a computer readable memory and executed by a processor subsystem.

Program execution begins at the start state 305. As described above, a user operating the ripe watermelon detector places the transducers 130 and 140 of the detector 100 in contact with a watermelon W to be tested and initiates operation by pressing the start button. Upon detecting an operation initiation command, the detector control circuit transitions to the 310 state.

In the transmit state 310, the control circuit directs the transmitter transducer 140 to transmit a sonic test signal to the melon W under test. The test signal may consist of a single output waveform containing a combination of test frequencies. Alternatively, the test signal may consist of a sequence of test frequencies emitted singly or in combinations. In yet another embodiment, the test signal may be a random signal noise signal containing a range of frequencies.

The frequencies chosen for transmission by the transmitting transducer are chosen to overlap a frequency range of interest for detecting the ripeness of a particular class of fruits such as melons. The frequency range of interest is a range of resonant frequencies for ripe fruit of a particular class or type. For melons, such as watermelons, the frequency range of interest is between 100 Hz and 200 Hz, which indicates a ripe melon. In a preferred embodiment, the transmission frequencies include frequencies significantly below and above the frequency range of interest to allow positive indication of non-ripeness by detecting resonant frequencies outside of the range of interest.

Following the transmission of a test signal, the control circuit enters the receiving state 320. In the receiving state 320, the control circuitry controls the receiving transducer 130 to receive oscillations from the watermelon W in response to sound transmitted to the frequency. The process of controlling the receiving transducer 130 may include delaying reception to mask the transmitted tones, echo cancellation of the transmitted frequency, or amplitude/phase compensation of the received signal to compensate for a non-linear transfer curve of the receiving transducer 130. A digitized representation of the data may be stored in memory such as RAM.

If the data received from the receiving transducer indicates an unsuccessful attempt to capture the sound from the transducer, the control circuit may return to the transmitting state 310 to repeat the transmission attempt. The control circuit may indicate that transmission has failed using by sending an appropriate message to the display or providing an indication via one or more of the indicators. For example, a tone may be generated using the speaker to indicate an unsuccessful attempt to determine the ripeness of a melon.

Upon successfully receiving data representing the sound returned from the watermelon W, control transitions to the state an analysis state 330 where the resonant frequency FR is determined. The resonant frequency is the frequency of sound returned with the largest amplitude. The analysis step may comprise performing a FFT analysis to translate the returned data from a time to a frequency domain and analyzing the result to determine the strongest frequency. Alternatively, the amplitudes of individually returned tones may be compared to determine the strongest return frequency. An analog system including a system of band filters and comparators may alternatively be used to identify the resonant frequency. If the analysis returns a definite result, program control proceeds to the ripeness determination function, but if the result is inconclusive, an indeterminate or failed result may be indicated using one or more of the indicator systems described above. An indeterminate result may be indicated when no frequency has a significantly strong amplitude as to indicate a detected resonance.

Blocks 340, 370, 380, 430, and 410 and the associated process flow paths comprise a representation of a process for determining the ripeness of a melon from the determined resonant frequency F_{R}. The process starts at block overripe detect in which the resonant frequency is compared to a lower frequency set point corresponding to the lower end of the frequency range of interests for a melon. If the determined resonant frequency F_{R} is lower than the lower frequency set point, then control proceeds along path 350 to block 370. In state 370, the control circuit controls the ripe watermelon detector outputs, such as one or more indicators or the display, indicate that the watermelon W is overripe. The indication may be a qualitative indication simply indicating that the melon is overripe, or the indication may be quantitative indicating an increased degree condition of over ripe as the frequency F_{R} is further below the lower frequency set point.

If the frequency F_{R} is greater than or equal to the low frequency set point, the control proceeds along path 360, to block 380. At block 380, the determined frequency F_{R} is compared to an upper frequency set point corresponding to the upper frequency of the frequency range of interest. If the frequency F_{R} is greater the upper frequency set point, program control transitions via path 400 to block 430 where the display and indicators are controlled to indicate a condition of under ripe for the melon under test. The indication may be qualitative indication that the melon is under ripe, or a quantitative indication based on the difference between frequency F_{R}, and the high frequency set point may be provided.

If the frequency F_{R} is less than or equal to the lower frequency set point, process control transitions from state 380 to state 410 via path 390. In this state 410, the control circuit controls the display and the indicators to indicate that the melon W is ripe. The indication may be a simple indication that the melon is ripe, or the indication may be quantitative based on a correlation of the value of F_{R} to the frequency range of interest or a comparison of F_{R} to an optimum frequency value for the melon.

After the ripeness evaluation is completed at blocks 410, 370, or 430, control transfers to the stop state 420 and the process ends. In the preferred embodiment, operating the control button 120 from any state may cause control to return the start state 305 restarting the process.

The various devices, components, and entities described above and illustrated in block diagram form may be implemented using hardware, software or a combination thereof and may be implemented in a computer system or other processing system. In the described one embodiment, these elements are implemented using a computer system capable of carrying out the functionality described with respect thereto. Various software embodiments are described in terms of this example computer system. After reading this description, it will become apparent to a person skilled in the relevant art how to implement the invention using other computer systems and/or computer architectures. In another embodiment, the elements are implemented primarily in hardware using, for example, hardware components such as application specific integrated circuits (ASICs). Implementation of the hardware state machine so as to perform the functions described herein will be apparent to persons skilled in the relevant art(s).

In yet another embodiment, elements are implemented using a combination of both hardware and software.

The transducers for receiving and transmitting sound have been described as piezoelectric based transducers. Any suitable transducers for converting sound to an electrical signal or for generating sounds of the desired frequency may be used. For example the receiver may be a magnet/movable coil transducer.

A portable embodiment of the ripe watermelon detector has been described. The invention is not limited to portable implementations of the detector. For example, the transducers may build into a fixed equipment platform over which the melons are placed with a detection cycle initiated when a melon is determined to be in contact with the transducers.

The frequency range of interest for melons, for example, watermelons, is preferably 100 Hz to 200 Hz. An embodiment of the invention may employ a different frequency range for testing ripeness of fruits other than watermelons. In another embodiment of the invention, the frequency range may be selectable using an operator control.

As an alternative to the frequency measurement method of evaluating ripeness, other analyses may be used to evaluate ripeness. For example, a frequency return spectrum expected from a ripe melon may be stored in non-volatile memory. A correlation of the stored spectrum with the return spectrum of melon under test may be computed with result being used to evaluate ripeness of the melon under test. The return spectrum may be computed by performing an FFT analysis of the sampled sound values received by the receiver transmitter.

It is to be understood that the present invention is not limited to the embodiments described above, but encompasses any and all embodiments within the scope of the following claims.

I claim:

1. A ripe melon detector, comprising:
a sound transmitting transducer adapted for transmitting a sound signal to a melon;
a sound receiving transducer adapted for receiving a reflection of the sound signal from the melon;
a control circuit in electrical communication with the sound transmission transducer and the sound receiving transducer for controlling transmission and reception of the sound signal over a plurality of frequencies, for determining a resonant frequency of the sound signal, and for comparing the determined resonant frequency with a reference resonant frequency in order to determine ripeness of the melon; and
an indicator in electrical communication with the control circuit for indicating the ripeness of the melon.

2. The ripe melon detector of claim 1, wherein said sound transmitting transducer is a piezoelectric sound generator, driven by an alternating current waveform, containing one or more frequency components in said control circuit.

3. The ripe melon detector of claim 1, wherein said sound receiving transducer is a second piezoelectric device operated to convert mechanical vibrations generated in the melon into an electric signal.

4. The ripe melon detector of claim 1, wherein said control circuit includes a processor subsystem made up of a microprocessor/digital signal processor (DSP) combination, wherein said DSP is a processing unit optimized for carrying out signal analysis.

5. The ripe melon detector of claim 4, wherein said processing unit optimized for carrying out signal analysis is configured to perform a Fast Fourier Transform (FFT) procedure.

6. The ripe melon detector of claim 4, wherein said control circuit is configured wherein a correlation of the frequency domain representation of the received sound and a stored frequency domain of an expected received signal for a ripe fruit is computed, with the resulting correlation providing an indication of ripeness of the fruit.

7. The ripe melon detector of claim 1, wherein said ripeness indicator comprises at least one audio speaker.

8. The ripe melon indicator of claim 1, wherein said ripeness indicator comprises at least one indicator light.

9. The ripe melon indicator of claim 1, wherein said ripeness indicator comprises a text message device for indicating the states of ripeness of target melons.

10. The ripe melon detector of claim 9, wherein said text message device further comprises means for providing diagnostic information indicating proper operation of said control circuit.

11. A ripe melon detector, comprising:
a sound transmitting transducer adapted for transmitting a sound signal to a melon;
a sound receiving transducer adapted for receiving a reflection of the sound signal from the melon;
a control circuit in electrical communication with the sound transmission transducer and the sound receiving transducer for controlling transmission and reception of the sound signal over a plurality of frequencies, for determining a resonant frequency of the sound signal, and for comparing the determined resonant frequency with a reference resonant frequency in order to determine ripeness of the melon;
said control circuit including a processor subsystem made up of a microprocessor/digital signal processor (DSP) combination, wherein said DSP is a processing unit optimized for carrying out signal analysis, said processing unit optimized for carrying out signal analysis being configured to perform a Fast Fourier Transform (FFT) procedure; and
an indicator in electrical communication with the control circuit for indicating the ripeness of the melon.

12. The ripe melon detector of claim 11, wherein said sound transmitting transducer is a piezoelectric sound generator, driven by an alternating current waveform, containing one or more frequency components in said control circuit, and said sound receiving transducer is a second piezoelectric device operated to convert mechanical vibrations generated in the melon into an electric signal.

13. The ripe melon detector of claim 11, wherein said ripeness indicator comprises at least one audio speaker.

14. The ripe melon indicator of claim 11, wherein said ripeness indicator comprises at least one indicator light.

15. The ripe melon indicator of claim 11, wherein said ripeness indicator comprises a text message device for indicating the states of ripeness of target melons.

16. The ripe melon detector of claim 11, wherein said text message device further comprises means for providing diagnostic information indicating proper operation of said control circuit.

17. A ripe melon detector, comprising:
a sound transmitting transducer adapted for transmitting a sound signal to a melon;
a sound receiving transducer adapted for receiving a reflection of the sound signal from the melon;
a control circuit in electrical communication with the sound transmission transducer and the sound receiving transducer for controlling transmission and reception of the sound signal over a plurality of frequencies, for determining a resonant frequency of the sound signal, and for comparing the determined resonant frequency with a reference resonant frequency in order to determine ripeness of the melon, wherein said control circuit is configured such that a correlation of the frequency domain representation of the received sound and a stored frequency domain of an expected received signal for a ripe fruit is computed, with the resulting correlation providing an indication of ripeness of the fruit, and
an indicator in electrical communication with the control circuit for indicating the ripeness of the melon.

18. The ripe melon detector of claim 11, wherein said sound transmitting transducer is a piezoelectric sound generator, driven by an alternating current waveform, containing one or more frequency components in said control circuit, and said sound receiving transducer is a second piezoelectric device operated to convert mechanical vibrations generated in the melon into an electric signal.

19. The ripe melon indicator of claim 17, wherein said ripeness indicator comprises a text message device for indicating the states of ripeness of target melons.

20. The ripe melon detector of claim 17, wherein said text message device further comprises means for providing diagnostic information indicating proper operation of said control circuit.
